(19) United States
(12) Patent Application Publication
(10) Pub. No.: US 2004/0265104 A1
(43) Pub. Date: Dec. 30, 2004

(54) Container transporting device

(76) Inventor: Burnett Davis JR., Dallas, TX (US)

Correspondence Address: Delphine M. James, Attorney-at-Law, Ste. 170, 2656 South Loop West, Houston, TX, 77054, US

(21) Appl. No.: 10/603,020

(22) Filed: Jun. 24, 2003

(51) Int. Cl. B62B 1/00

(52) U.S. Cl. 414/490

(57) ABSTRACT

The present invention is a handcart for lifting and transporting a container from an upright position. The handcart further comprises a base having at least one wheel means for movement. An elongated bar is securely attached to the base at its lower end and extends vertically upward a cradle is mounted upon the base for engaging the bottom of the container. An arm structure is connected to the bar and protrudes from the bar along its longitudinal axis. A catch mechanism is provided for engaging the neck of the container The catch mechanism is situated underneath the arm structure. A lever is operably associated with the catch mechanism and is connected to the upper end of the bar. A handle is attached to the bar at its upper end.

### BACKGROUND

Today, water containers that provide fresh water are utilized in many homes and businesses in the United States. Because the weight of a container increases substantially when it is filled with water, it is a difficult task to transport the container without some type of support. What is needed for these water containers is a simple and easy mechanism for lifting and transporting.

There are several patented mechanical apparatus that provide the capability to transport water containers such as U.S. Pat. No. 5,372,470 which discloses a manually movable lift truck for transporting containers and U.S. Pat. No. 5,406,996 which discloses an apparatus to transport and place a water bottle onto a water dispenser.

However, the present invention allows the transportation of a container such as a 5 gallon container without lifting and bending and has a simple construction.

### SUMMARY

The present invention provides for a utility hand cart for transporting large water containers or other such compatible containers. The containers can range in size from five to eight gallon. The utility cart provided allows the container to be loaded onto the cart without bending or using physical force. The utility cart includes a base frame, an elongated bar, a hand assembly, and an arm structure. The elongated bar is attached to the base frame. The handle assembly is attached to the upper end of the elongated bar and provides the capability of steering and maneuvering the utility cart. The arm structure is mounted on the exterior surface of the elongated bar. The present invention includes a means for loading the container onto the base frame and a catch mechanism integrated into the arm structure for engaging the top of the container.

### BRIEF DESCRIPTION OF DRAWINGS

The drawings and the accompanying description illustrate the present invention.

FIG. 1 is a perspective side view of one embodiment of the present invention a handcart for transporting water containers.

FIG. 1A illustrates a rear view of one embodiment of the present invention a hand cart for transporting water containers.

FIG. 2 illustrates an exploded view of the handcart holding the water container.

FIG. 3 illustrates a cross-sectional side view of the handcart.

FIG. 3A illustrates a cross-sectional back view of the handcart.

FIG. 4 illustrates an exploded view of the underside portion of the arm structure of the handcart.

FIG. 5-5C illustrates an alternative embodiment of the present invention, the handcart utilizing a spring arch.

FIG. 6-6A illustrates an alternative embodiment for the elongated bar member.

FIG. 8A-8D illustrates an alternative embodiment of the present invention, the handcart utilizing a second type of spring arch connection.

FIG. 7A-7B illustrates an alternative embodiment of the present invention, the handcart utilizing a hook.

### DETAILED SPECIFICATION

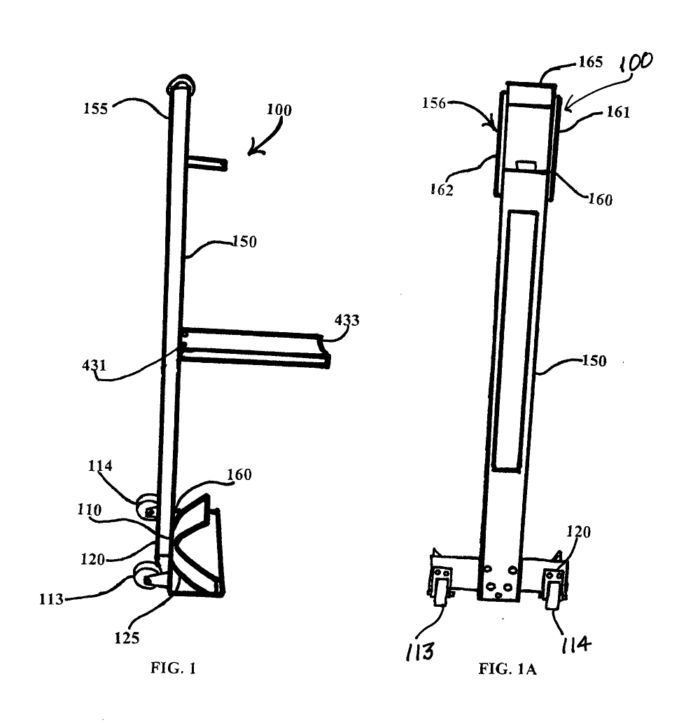

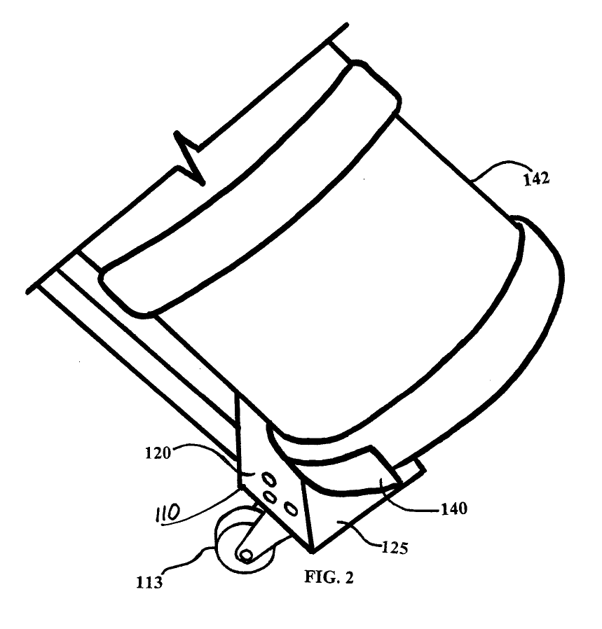

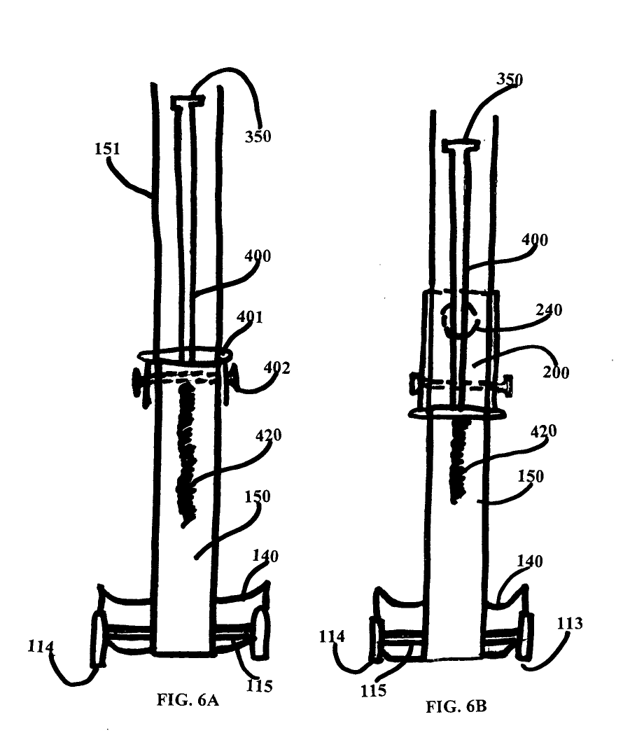

Referring to FIG. 1, there is shown a perspective side view of hand cart (100) according to the present invention. The present invention includes a base frame (110) that is supported by at least one wheel means (115) for movement. In the illustrated embodiment, the base frame (110) is supported by two conventional wheels (113, 114). The hand cart can be made of rigid metal such as aluminum, steel, hard plastic or another such suitable material. As illustrated, base frame (110) further includes an integrated rigid vertical plate member (120) and a rigid horizontal plate member (125). The horizontal plate member (125) is aligned perpendicular to the vertical plate member (120). Conventional wheel means (113, 114) are respectively mounted upon opposite ends of vertical plate member (120) to support the movement of handcart (100). As shown, the conventional wheels (113, 114) are securely fastened to the vertical plate member via screw bolts as illustrated in FIG. 1A. In alternative embodiments of the present invention, as shown in FIGS. 6A and 6B, wheel means (113, 114) are situated on opposite ends of an axle (115) that runs through the bottom of the elongated bar member (150).

Referring to the illustrated embodiment in FIG. 2, there is shown an exploded view of the base frame (110) supporting a container (142). As illustrated the present invention further includes a cradle (140) supported by the base frame (110). In the specific illustrated embodiment, the cradle (140) is dimensioned to fit the bottom of the container (142). Cradle (140) has an arc shape dimensioned to fit the circular shape of the bottom of the container (142) shown in FIG. 2. However, in other specific embodiments, where the bottom of the container is polygonal or elliptical, the cradle (140) can be dimensioned to engage the bottom of these types of containers. The cradle (140) is supported by the horizontal plate member (125) and securely fastened at its midpoint to the vertical plate member (120). In the illustrated embodiment screw bolts are used to secure the cradle (140) to the vertical plate member (120) of the base frame (110). In another embodiment of the present invention, as shown in FIG. 6A and 6B, the vertical plate member is eliminated. In this kind of embodiment, the cradle (140) is supported by the horizontal plate member (125) and attaches directly to the elongated bar member (150).

Referring back to FIG. 1, the illustrated embodiment further includes an elongated bar member (150) defined by an upper end (155) and a lower end (160). The lower end (160) is securely fastened to the backside of the vertical plate member (120) of base frame (110), as shown in FIG. 1A.

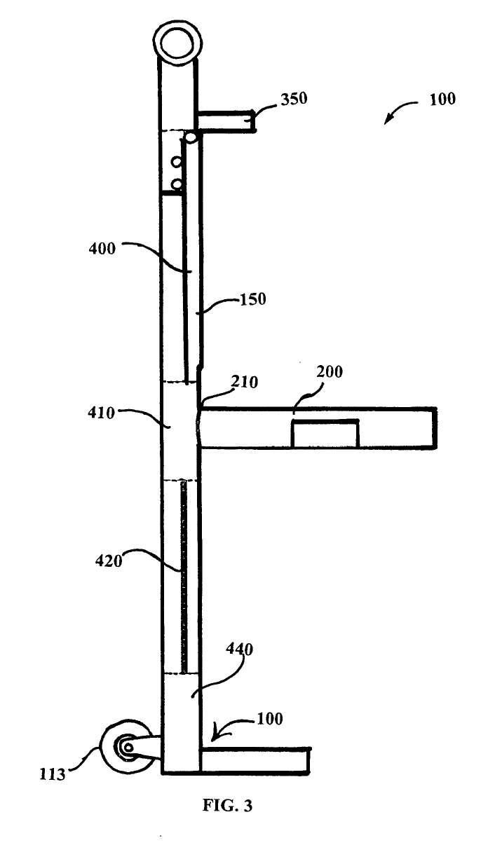

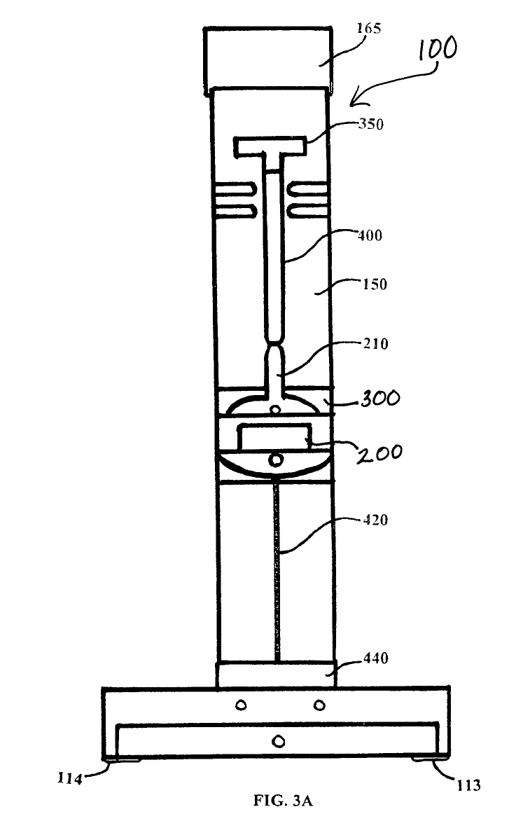

Referring to FIG. 3, there is shown an exploded cross-sectional view of handcart (100). In the illustrated embodiment, the elongated bar member (150) is hollow and has essentially a rectangular shape. In an alternative embodiment of the present invention as shown in FIG. 6A, the elongated bar member (150) can be formed from a solid sheet of metal. In this kind of embodiment, the sheet of metal is bent backward along its vertical edges (151) to form a casing with an opened back.

The illustrated embodiment in FIG. 1, further includes handle assembly (156) to provide the capability of steering and maneuvering the hand-cart (100). Handle assembly (156) further includes parallel spaced apart support members (161, 162) having their upper ends connected to grip member (165) and their lower ends securely mounted upon the lower end (160) of bar member (150). As shown, the parallel support members (161, 162) are securely fastened to the lower end (160) of bar member (150) at each opposite side. In the illustrated embodiment, bolt screws securely fastened the support members (161, 162) to the bar member (150). However, other suitable fastening means can be utilized. The handle assembly (156) provides the capability of moving the handcart in a forward and backward position on the conventional axis of the wheel means (113, 114).

In the illustrated embodiment in FIG. 3A, handcart (100) further includes an arm structure (200) being mounted upon the exterior of the bar member (150). Arm structure (200) is adapted to be partially slidably through slot opening (210) located on the exterior of bar member (150). Additionally, arm structure (200) is mounted on the exterior of bar member (150) at an intermediate point. This intermediate point is determined in relation to the height of the container as the container sits upright upon the base frame. As shown, arm structure (200) extends outwardly along its horizontal axis and is essentially a polygonal shape, specifically rectangular. In yet other embodiments of the present invention, the shape of the arm structure (200) can be adjusted to meet design implementation of the various types of containers.

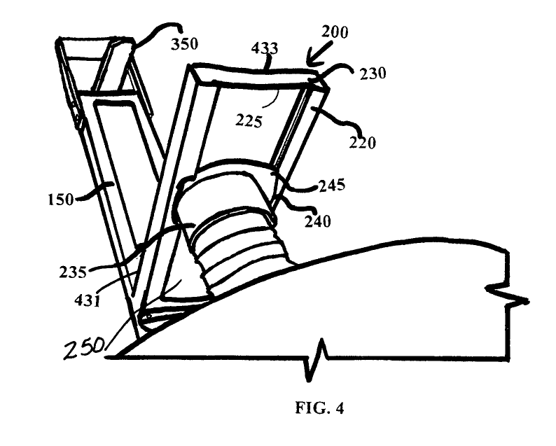

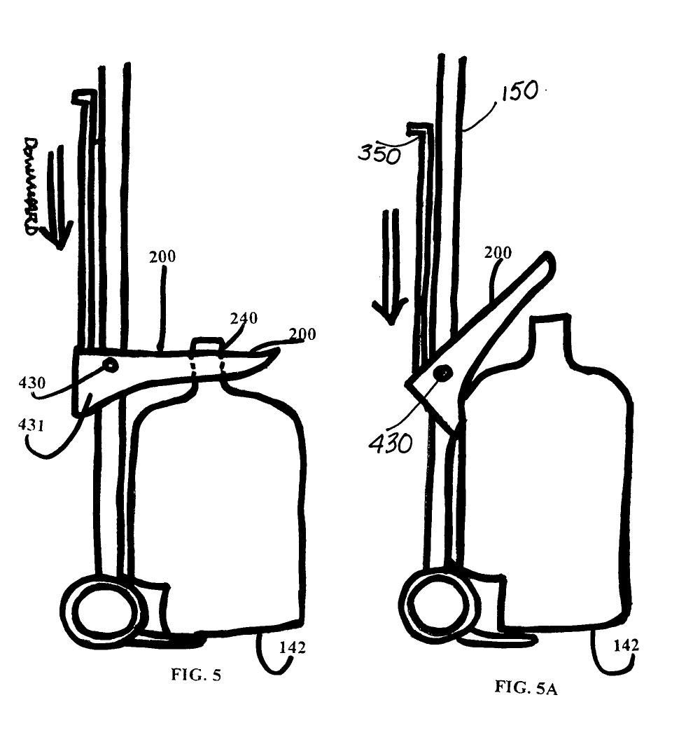

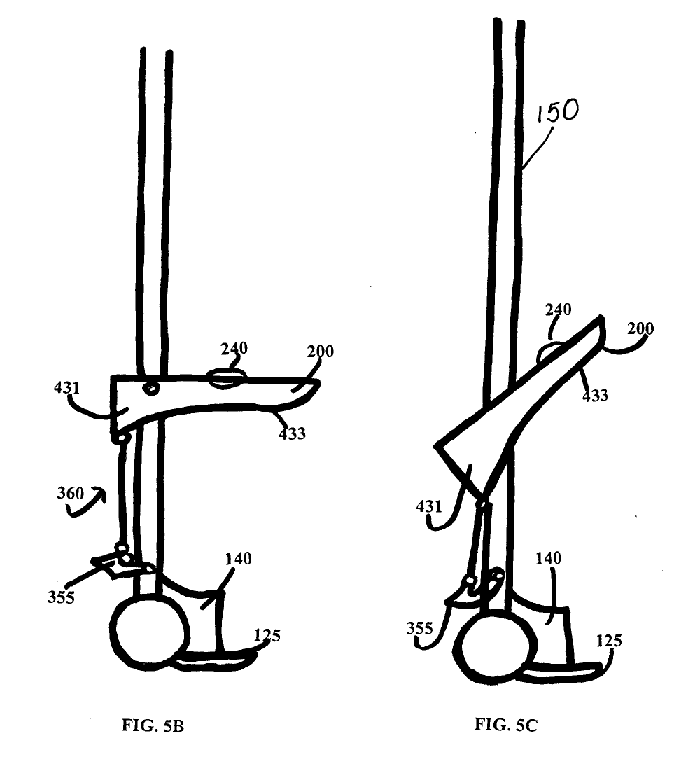

Referring to FIG. 4, there is shown an exploded view of arm structure (200). In the illustrated embodiment, arm structure (200) is further defined by a first edge (431), an opposite second edge (433), and an underside portion (220). Bumper mechanism (225) is situated at the first end (431) of arm structure (200). As shown bumper mechanism (225) has a curved groove (230) dimensioned to fit the curvature of the neck of the container. In an alternative embodiment, the bumper mechanism can be the straight opposite second edge (433). The underside portion (220) is adapted to receive the top of neck (235) of the container. The underside portion (220) further includes catch mechanism (240) situated within the underside portion (220). In the illustrated embodiment, catch mechanism (240) is dimensioned to accommodate the dimensions of the top of neck (235). As shown, catch mechanism (240) further includes a recess (245) in the underside portion (220). In the illustrated embodiment, recess (245) has a polygonal shape equivalent to the shape and dimensions of the top of the neck of the illustrated container. Additionally, recess (245) is situated from the far end of the arm structure (200) wherein the top of the container can be aligned directly underneath the recess (245) when the container is in an upright position on the base frame. In alternative embodiments, the catch mechanism (240) can be a mechanical device situated within the underside portion and can be adapted to engage the top of various styles of containers. In even more specific embodiments, recess (245) can be adapted to fit various styles of containers. In other embodiments of the present invention, as shown in FIG. 5, the catch mechanism (240) can be an orifice through the arm structure (200) having dimensions to accommodate the diameter of the top of the container.

The present invention further includes a means for raising and lowering the arm structure (200) such that catch mechanism (240) in the underside portion (220) can securely engage the top of the container. In the illustrated embodiment, a lever mechanism (350) is provided that is situated at the upper end of the bar member (150). Lever mechanism (350) is operably connected through the interior of the bar member (150) to the arm structure (200). The lever mechanism (350) connection allows the arm structure (200) to be vertically lifted and lowered such that the catch mechanism (240) can engage the top of the neck of the container. As illustrated in the alternative embodiment in FIG. 6A, the lever mechanism can be situated internally within the casing of the elongated bar member (150).

Referring to FIGS. 3 and 3A, there is shown one embodiment of the lever mechanism (350) connection. In the illustrated embodiment in FIG. 3A, arm structure further includes its rear end (250) mounted to a carriage block (300) through a small slot opening (210) located on the exterior of bar member (150). Carriage block (410) is rectangular in shape and is dimensioned to fit within bar member (150). The illustrated embodiment further includes rod member (400) interconnecting lever mechanism (350) to carriage block (410). At the lower end of bar member (150) is a second stationary block (410). Spring member (420) interconnects the carriage block (410) and the stationary block (410) such that when lever mechanism (350) is pulled up the arm structure (250) can be raised. Additionally, when the lever mechanism (350) is released, the arm structure (250) is lowered to allow the catch mechanism (240) to engage the top of the container. The slot opening (210) provides the maximum distance the arm structure (200) can be raised and lowered. In alternative embodiments, the lever mechanism (350) can be implemented utilizing mechanical pulley systems.

In other embodiments of the present invention, carriage block (410) and (440) can be eliminated. In this kind of embodiment as shown in FIGS. 6A and 6B, the rod member (400) and the spring member (420) are each respectively attached to screws (401, 402) that horizontally secure arm (200) to the bar member (150).

In the alternative embodiment of the present invention, as shown in FIGS. 5A and 5C, the arm structure (200) can be raised and lowered to at least a thirty-degree angle utilizing a spring-arch method. In this kind of embodiment, the first edge (431) of arm structure (200) is hingedly connected to the exterior of the elongated bar (150) at an intermediate point. In this alternative embodiment, the arm structure (200) is pivoted upward along a thirty-degree angle path as the cradle engages the bottom of the container. Then, the arm structure (200) is lowered along the same thirty-degree angle path allowing the catch mechanism (240) to engage the top of the container. The arm structure (200) is connected to the elongated bar member (150) through a spring-loaded hinge (430) which allows the arm structure (200) to remain in a down position with the catch mechanism (240) situated within the arm structure (200) securely engaging the top of the container. In the illustrated embodiment, the catch mechanism (240) can be the orifice illustrated in FIG. 5 or the recess (245) illustrated in FIG. 4.

In the embodiment illustrated in FIG. 6, lever mechanism (350) further comprises a solid rod (400) which is situated internally within the elongated bar (150). Rod (400) is held in place by special hardware, which allows the rod (400) to slide up and down. Additionally, rod (400) is connected to first edge (431) of the arm structure (200) such that lever (350) can be pushed downward to raise the arm structure (200) and disengage the catch mechanism (240) as illustrated in FIG. 5A.

In yet another alternative embodiment as shown in FIGS. 5B and 5C, lever mechanism (350) can be connected to a foot bar (355). In this illustrated embodiment, a cable (360) connects foot bar (355) to first edge (431) of the arm structure (200). When the foot bar (355) is depressed, the arm structure (200) is raised upward disengaging the catch mechanism (240). When the foot bar (355) is released, the arm structure (200) is lowered to securely engage the catch mechanism (240) with the top of the container.

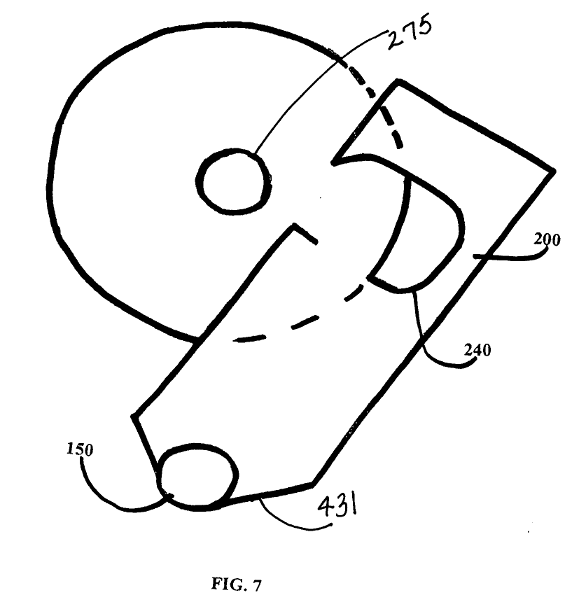

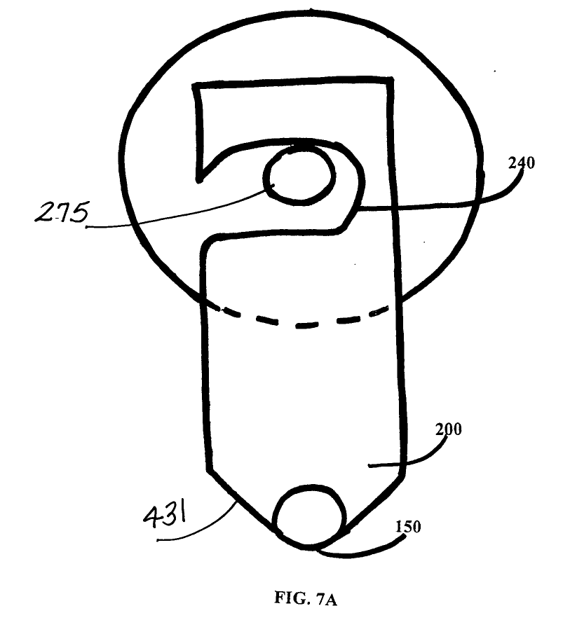

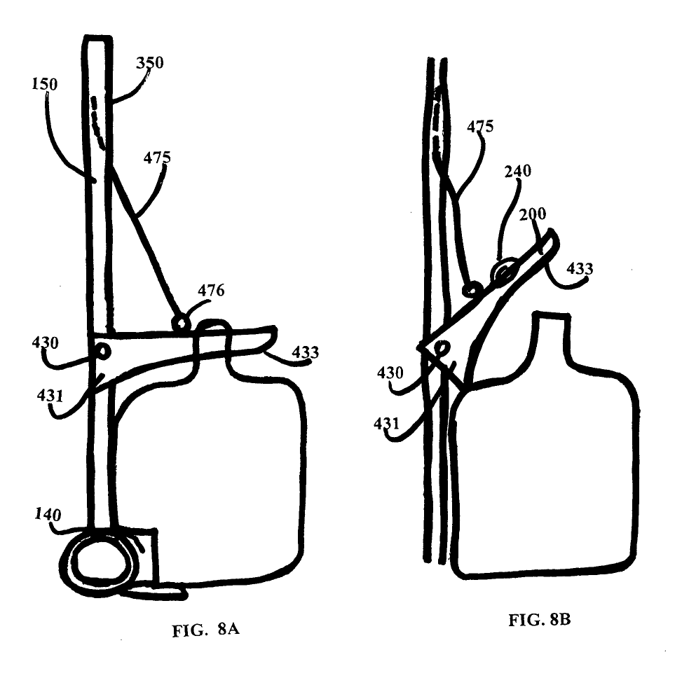

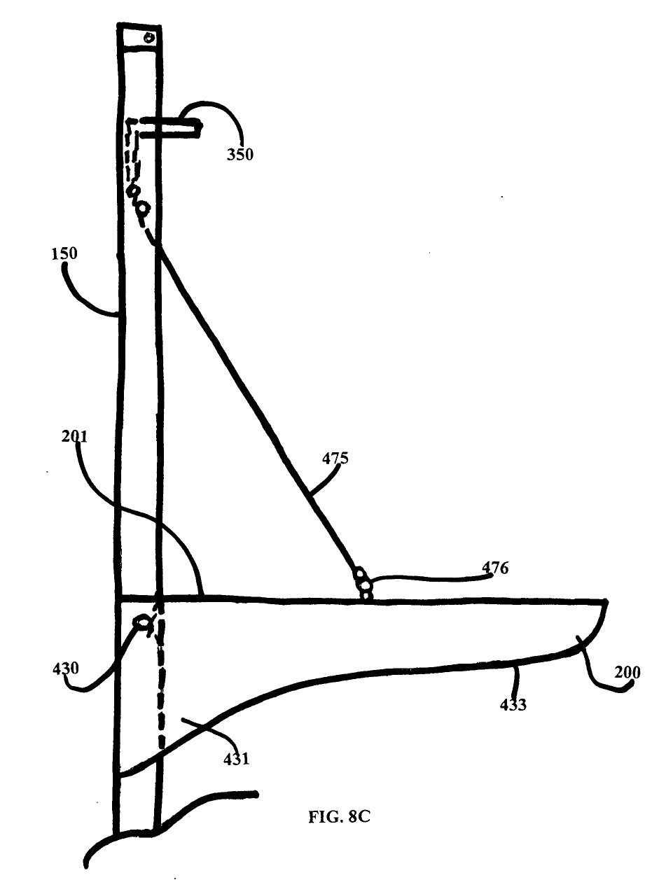

In FIGS. 8A-8D, there is shown an alternative embodiment of the present invention utilizing the spring arch method. In this illustrated embodiment in FIG. 8A, lever mechanism (350) is located at the upper end of elongated bar member (150) and is operably connected at an intermediate point (476) to the upper surface of arm structure (200). The first edge (201) of arm structure (200) is hingedly connected to the exterior of elongated bar member (1 50). In the shown embodiment, cable (480) is connected to arm structure (200) at the intermediate point (476) such that when lever mechanism (350) is pulled upward cable (475) raises arm structure (200) upward. As shown in FIG. 8B, when lever mechanism (350) is pulled upward, the arm structure (200) is raised to at least a thirty degree angle path to disengage catch mechanism (240).

In another alternative embodiment of the present invention, as shown in FIG. 7 and 7A, the arm structure (200) is rotated to at least thirty-degree angle to engage and disengage the catch mechanism (240). In the illustrated embodiment, first edge (431) of the arm structure (200) is rotably connected to the exterior of horizontal bar member (150) at an intermediate point. Arm structure (200) further includes a U-shaped hook catch mechanism (240) with dimensions to accommodate the diameter of the neck of the container. The U-shape hook catch mechanism (240) extends laterally from a side edge of the arm structure (200) to an intermediate position. In this kind of embodiment, the arm structure (200) is rotated clockwise thirty degrees to allow the bottom of the container to slide on the base frame and the cradle to engage the bottom of the container. To engage the catch mechanism (240) the arm structure (200) is rotated back counterclockwise along the same path to allow the catch mechanism (240) to engage the neck of the container (275). In the illustrated embodiment, elongated bar member (150) is cylindrical in shape. In this kind of embodiment elongated member (150) can be made from cylindrical PVC pipe as shown in FIGS. 7 and 7A.

Operationally, place the hand-cart in an upright position with the cradle aligned with the bottom of the container. With the bar member perpendicular to the floor and parallel to the container with the arm structure aligned perpendicular to the top of the container, place one hand on the hand assembly and place the corresponding foot at the bottom of the elongated bar against its rear side. The handle assembly is moved forward such that the bumper mechanism of the arm structure contacts the side of the neck of the container and forces the bottom of the container to slightly lift at a small degree angle from the surface level. Simultaneously, the base frame is pushed forward with the foot allowing the horizontal plate member of the base frame to slide underneath the bottom of the container. As the horizontal plate member is slid underneath the bottom of the container, the arc of the cradle engages the bottom of the container. The lever mechanism is pulled upward causing the arm structure to partially slide upward. The lever mechanism is then released which causes the arm structure to slide downward and the catch mechanism to engage the top of the container. In an alternative embodiment of the present invention, the lever mechanism is pulled upward causing the arm to be raised along at least a thirty-degree angle path. After the arm structure is raised, the handcart is moved into an upright position aligning the neck of the container directly underneath the catch mechanism. When the lever mechanism is released, the catch mechanism in the arm structure engages the top of the neck of the container. In another embodiment of the present invention, the arm structure is rotated clockwise at least thirty degrees to allow the container to be placed upon the bottom of the container. The arm structure is then rotated back to allow the catch mechanism to engage the neck of the container. After the container is securely placed upon the base frame, the container can then be transported to its desired location. The major advantage of utilizing the handcart is that to place the container on the handcart, a person does not have to bend or utilize any physical force.

What is claimed is:

1. A hand cart for lifting and transporting a container with a tapering neck at its upper end, the hand cart comprising:
a base frame having at least one wheel means for movement;
a cradle for engaging the bottom of the container, the cradle being supported by the base frame;
an elongated bar being defined by an upper end and a lower end; the lower end being securely attached to the base frame and the cradle;
an arm structure being defined by a first edge and an opposite second edge, the first edge being mounted to the exterior of the bar at an intermediate point, the intermediate point being at a position relative to the height of the container from the base frame, the arm structure extending outwardly from the first edge along its horizontal axis to a set distance to the opposite second edge;
a bumper mechanism integrated into the opposite second edge at the set distance therein, the bumper mechanism for contacting the neck of the container thereby causing the container to tilt forward as the container is loaded onto the base frame;
a catch mechanism within the arm structure;
a means for engaging and disengaging the catch mechanism with the top of the container; and
a hand assembly being mounted upon the upper end of the bar such that the hand-cart can be moved into a forward and backward position upon the wheel means.

2. The handcart of claim 1 wherein the catch mechanism further comprises:
a recess situated within the underside portion of the arm structure;
the recess dimensioned to accommodate the circumference of the top of the container; and
the recess being situated from the first edge of the arm structure at a position which allows the top of the container to align directly underneath the recess as the bottom of the container is placed on the base frame.

3. The handcart of claim 1 wherein the catch mechanism further comprises:
an orifice situated within the of the arm structure;
the orifice having dimensions to accommodate the circumference of the top of the container; and
the orifice being situated from the first edge of the arm structure at a position which allows the top of the container to align directly underneath the orifice as the bottom of the container is placed on the base frame.

4. The handcart of claim 1 wherein the hand assembly further comprises:
a pair of parallel spaced apart support members;
the pair of support members each having an upper and lower end;
a grip member connected to each upper end; and
each lower end mounted upon the upper end of the bar member.

5. The handcart of claim 1 wherein the means for engaging and disengaging the catch mechanism further comprises:
a lever mechanism situated at the upper end of the bar; and
the lever operably connected through the interior of the bar to the first edge of the arm structure;
the first edge of the arm structure being partially slideably mounted upon the exterior of the elongated bar wherein the lever mechanism can vertically lower and lift the arm structure to respectively engage and disengage the catch mechanism with the top of the container.

6. The handcart of claim 1 wherein the cradle is dimensioned to fit the bottom of the container.

7. The handcart of claim 6 wherein the base frame further comprises:
a rigid vertical plate member and a rigid horizontal plate member; the horizontal plate member being aligned perpendicular to the vertical plate member; and
the cradle being supported by the horizontal plate member; and
the vertical plate member being securely coupled to the cradle and the bar member.

8. The handcart of claim 6 wherein the base frame further comprises:
a rigid horizontal plate member;
the cradle being supported by the horizontal plate member; and
the cradle being securely coupled to the bar member.

9. The handcart of claim 4 wherein the arm structure has a polygonal shape.

10. The hand cart of claim 1 wherein the bumper mechanism is a recess within the opposite second edge of arm structure dimensioned to fit the curvature of the neck of the container.

11. The hand cart of claim 1 wherein the bumper mechanism is the opposite second edge of the arm structure.

12. The handcart of claim 1 wherein the means for engaging and disengaging the catch mechanism further comprises:
a lever mechanism situated at the upper end of the bar; and
the lever operably connected through the interior of the bar to the first edge of the arm structure;
the first edge of the arm structure being hingedly connected to exterior of the elongated bar such that the lever mechanism can raise and lower the arm structure along at least a thirty degree angle path to respectively engage and disengage the catch mechanism with the top of the container.

13. The handcart of claim 1 wherein the means for engaging and disengaging the catch mechanism further comprises:
a lever mechanism situated at the lower end of the bar; and
the lever mechanism operably connected through the interior of the bar to the first edge of the arm structure;
the first edge of the arm structure being hingedly connected to exterior of the elongated bar such that the lever mechanism can raise and lower the arm structure along at least a thirty degree angle path to respectively engage and disengage the catch mechanism with the top of the container.

14. The handcart of claim 1 wherein the means for engaging and disengaging the catch mechanism further comprises:
a lever mechanism situated at the lower end of the bar; and
the lever mechanism operably connected at an intermediate point to the upper surface of the arm structure;
the first edge of the arm structure being hingedly connected to exterior of the elongated bar such that the lever mechanism can raise and lower the arm structure along at least a thirty degree angle path to respectively engage and disengage the catch mechanism with the top of the container.

15. The handcart of claim 1 wherein the catch mechanism further comprises:
an U-shape slotted hook situated within the arm structure; and
the U-shape slotted hook dimensioned to accommodate the circumference of the top of the container
the U-shaped hook extending laterally from a side edge of the arm structure at a an intermediate position which allows the hook to engage the neck of the container as the bottom of the container is placed on the base frame.

16. The handcart of claim 15 wherein the means for engaging and disengaging the catch mechanism further comprises:
the first edge of the arm structure being rotatably connected to exterior of the elongated bar such that the arm structure can rotate clockwise and counterclockwise along at least a thirty degree angle path to respectively engage and disengage the catch mechanism with the top of the container.

17. The handcart of claim 16 wherein the elongated bar member has a cylindrical shape.

18. The hand cart of claim 1 wherein the elongated bar is formed from a sheet of rigid metal material with its vertical edges bent backward to form an opened back casing.

19. The hand cart of claim 1 wherein the elongated bar is a hollow rectangular casing formed from a rigid metal material.

20. A method of lifting and transporting a container from an upright position, the method comprising:
a. providing a hand cart with a base frame supporting a cradle connected to an elongated bar with a handle mounted upon the top, an arm structure with a catch mechanism and a bumper mechanism, and lever mechanism operable connected to the arm structure;
b. placing the hand-cart with the elongated bar member perpendicular to the floor and parallel to the container with the arm structure aligned perpendicular to the top of the container;
c. placing a hand on the hand assembly;
d. placing the corresponding foot against the rear side of the bottom of the bar member;
e. pushing the hand assembly forward such that the bumper mechanism of the arm structure contacts the neck of the container tilting the bottom of the container at least thirty degrees;
f. simultaneously with step e, pushing the base frame forward with the corresponding foot such that the base frame slides underneath the bottom of the container and the cradle engages the bottom of the container;
g. pulling the lever mechanism to raise the arm structure to allow the container to sit upright on the base frame with the top of container aligned directly underneath the catch mechanism; and
h. releasing the lever mechanism for the catch mechanism to engage the top the container.

21. A hand cart for lifting and transporting a container from an upright position, the hand cart comprising:
a base frame having a rigid horizontal plate member supported by at least one wheel means for movement;
a cradle for engaging the bottom of the container, the cradle being supported by the horizontal plate member of the base frame;
an elongated bar being defined by an upper end and a lower end; the lower end being securely attached to the base frame and the cradle;
an arm structure being defined by a first edge and an opposite second edge, the first edge being mounted to the exterior of the bar at an intermediate point, the intermediate point being at a position relative to the height of the container from the base frame, the arm structure extending outwardly from the first edge along its horizontal axis to a set distance to the opposite second edge;
a bumper mechanism integrated into the opposite second edge at the set distance such that the neck of the container is contacted as the container is loaded onto the base frame;
a catch mechanism within the arm structure;
the catch mechanism further comprising:
an orifice situated within the of the arm structure;
the orifice having dimensions to accommodate the circumference of the top of the container; and
the orifice being situated from the first edge of the arm structure at a position which allows the top of the container to align directly underneath the orifice as the bottom of the container is placed on the base frame;
a lever mechanism situated at the upper end of the bar;
the lever operably connected through the interior of the bar to the first edge of the arm structure;
the first edge of the arm structure being partially slideably mounted upon the exterior of the elongated bar wherein the lever mechanism can vertically lower and lift the arm structure to respectively engage and disengage the catch mechanism with the top of the container; and
a hand assembly being mounted upon the upper end of the bar such that the hand-cart can be moved into a forward and backward position upon the wheel means.
